(19) United States
(12) Patent Application Publication
(10) Pub. No.: US 2009/0057305 A1
(43) Pub. Date: Mar. 5, 2009

(54) MODULAR CARGO TRAY

(76) Inventor: Serge Moreau, Newmarket (CA)

Correspondence Address: REISING, ETHINGTON, BARNES, KISSELLE, P.C., P O BOX 4390, TROY, MI, 48099-4390, US

(21) Appl. No.: 12/037,748

(22) Filed: Feb. 26, 2008

(30) Foreign Application Priority Data
Feb. 26, 2007 (CA) 2583770

(51) Int. Cl. B65D 6/02; B60R 9/055; B65D 6/16

(52) U.S. Cl. 220/4.27; 220/533; 220/532; 220/4.21; 224/330; 224/328

(57) ABSTRACT

A modular utility cargo tray is provided comprising a floor and a wall extending from the floor, the wall and the floor enabled for storage of items placed therein. The wall comprises at least a first pair of divider receiving members, oppositely disposed along the wall. The at least a first pair of divider receiving members comprises: a first level portion enabled to receive a divider generally disposed along the floor; and a second level portion enabled to receive and support a divider generally distal from the floor without interference from a divider received in the first level portion. the modular utility cargo tray is insertable into the cargo area of a vehicle, or converted to a cargo roof box by mating it with a second utility cargo tray.

### CROSS REFERENCE TO RELATED APPLICATION

This application claims priority to and benefit of Canadian Application Serial No. 2,583,770 filed Feb. 26, 2007, the entire contents of which is hereby incorporated by reference.

### FIELD

The specification relates generally to cargo trays for vehicles, and specifically to a modular cargo tray.

### BACKGROUND

Cargo trays for vehicles are in wide use, and generally consist of a tray which resides in the cargo area of a vehicle, such as a trunk or the cargo portion of a car, an SUV, station wagon, minivan and the like. Such cargo trays are generally configured to protect the cargo area of the vehicle from damage etc., which might be caused by the transport of cargo without the use of the cargo tray. For example, a user of the vehicle may wish to transport building and/or gardening materials, such as lumber, bricks, bags of cement (which may leak), bags of dirt, plants etc. which might damage the cargo area (i.e. scratch paint, stain upholstery etc.). Hence, the user of the vehicle may insert the cargo tray into the cargo area and place the materials into the cargo tray instead of directly onto the surfaces of the cargo area.

One example of such a cargo tray is provided by U.S. Pat. No. 6,752,304 which discloses a rear cargo storage assembly that is enabled to fit into a mating portion of a cargo area of a vehicle. Further, the cargo tray has oppositely opposed slots for insertion of special dividers thereby dividing the cargo tray into at least two portions along a given direction. However, the cargo tray of U.S. Pat. No. 6,752,304 is inherently limited as slots accept only the special dividers and further limit the division into portions along one axis.

Further, cargo trays are inherently limited by their use within the cargo area of the vehicle. Users such as contractors, week-end entrepreneurs and vacationers may require more space to transport materials and may resort to carrying materials on the roof of their vehicle. Hence a user will need to purchase a cargo roof box, which is generally complex and expensive, often with moving parts such as hinges etc. One example of such a cargo roof box is provided by U.S. Pat. No. 5,582,313 which discloses a deposit container of roof box type. The deposit container consists of four box parts which include two identical or nearly identical lid box halves and two identical or nearly identical bottom box halves, the lid halves and bottom halves can be interconnected to form a lid and bottom respectively. However the deposit container taught by U.S. Pat. No. 5,582,313 is complex with many parts for enabling the interconnection.

### SUMMARY

A first broad aspect of an embodiment seeks to provide a utility cargo tray comprises, a floor and a wall extending from the floor, the wall and the floor enabled for storage of items placed therein. The wall comprises at least a first pair of divider receiving members, oppositely disposed along the wall. The at least a first each pair of divider receiving members comprises: a first level portion enabled to receive a divider generally disposed along the floor; and a second level portion enabled to receive and support a divider generally distal from the floor without interference from a divider received in the first level portion. In some of these embodiments, the wall further comprises at least a second pair of divider receiving members enabled to receive a divider in at least a first level portion of the second pair of divider receiving members, such that a divider received in the first level portion of the second pair of divider receiving members is generally at an angle to a divider received in the second level portion of the first pair of divider receiving members. In other of these embodiments, the wall further comprises at least a second pair of divider receiving members, enabled to receive a divider in one of a first level portion and a second level portion of the second pair of divider receiving members, such that a divider received in one of the first level portion and the second level portion of the second pair of divider receiving members is generally at an angle to a divider received in the other of the first level portion and the second level portion of the first pair of divider receiving members.

A second broad aspect of an embodiment seeks to provide a modular cargo tray comprising a floor and a wall extending from the floor, the floor and the wall enabled for storage of items placed therein, the floor and the wall further enabled for at least one of insertion into a cargo area of a vehicle and securing to a roof of the vehicle, the wall comprising a rim. The modular cargo tray further comprises: a male portion generally disposed about a first portion of the rim; and a female portion generally disposed about a second portion of the rim, the male portion and the female portion being arranged generally symmetric to each other about a line bisecting the rim, such that when a second modular cargo tray is inverted over the modular cargo tray in a mating position, the male portion mates with the female portion of the second modular cargo tray and the female portion mates with the male portion of the second modular cargo tray.

In some embodiments of the first broad aspect, the male portion is generally continuously disposed about the first portion of the rim and the female portion is generally continuously disposed about the second portion of the rim.

In other embodiments of the first broad aspect, when the second modular cargo tray and the modular cargo tray are in the mating position, the male portion mating with the female portion of the second modular cargo tray and the female portion mating with the male portion of the second modular cargo tray generally creates a seal along each the rim of each the modular cargo tray. In some of these embodiments, a first end of the male portion is generally adjacent to a first end of the female portion along the rim, and a second end of the male portion is generally adjacent to a second end of the female portion along the rim. In other embodiments, at least one gap separates at least one of the first ends of each the male portion and the female portion along the rim, and the second ends of each the male portion and the female portion along the rim.

In further embodiments of the first broad aspect, each male portion comprises a plurality of male sub portions and the female portion comprises a plurality of female sub portions, each of the plurality of male sub portions arranged generally symmetric to a corresponding one of the plurality of female sub portions about the line bisecting the rim.

In yet further embodiments of the first broad aspect, securing to the roof of the vehicle comprises securing to a roof rack.

In some embodiments of the first broad aspect, at least one of the floor and the wall is enabled for receiving at least one attachment portion for removably attaching the modular cargo tray to the roof of the vehicle. In some of these embodiments, the at least one attachment portion comprises at least one u-bolt and apparatus for removably attaching the u-bolt to at least one of the floor and the wall. In other of these embodiments, the at least one attachment portion comprises at least one strap of a length for attaching the modular cargo tray to the roof of the vehicle, the strap comprises a strap securing portion. In some of these embodiments, at least one of the floor and the wall further comprises at least one of an exterior rib and an exterior groove for receiving the at least one strap.

In other embodiments of the first broad aspect, the modular cargo tray further comprises at least one pair of holes in the rim, each hole of the at least one pair of holes symmetrically disposed about the line bisecting the rim, wherein when the second modular cargo and the modular cargo tray are in the mating position, each hole of the at least one pair of holes lines up with a corresponding hole in a pair of holes in the rim of the second modular cargo tray. In some of these embodiments, each the hole is enabled to accept a securing apparatus for securing the second modular cargo tray to the modular cargo tray.

In further embodiments of the first broad aspect, the modular cargo tray further comprises apparatus for securing the second modular cargo tray to the modular cargo tray in the mating position.

In yet further embodiments of the first broad aspect, the male portion comprises a raised rib and the female portion comprises a recessed groove enabled to receive the raised rib. In some of these embodiments, the raised rib and the recessed groove are further enabled to interlock with each other.

In some embodiments of the first broad aspect, the floor, the wall, the male portion and the female portion form a generally unified body.

In other embodiments of the first broad aspect, the wall comprises at least a first pair of divider receiving members, oppositely disposed along the wall, enabled to receive at least one divider, thereby dividing the modular cargo tray into at least two sections. In some of these embodiments, each divider receiving member comprises: a first level portion enabled to receive a first divider generally disposed along the floor; and a second level portion enabled to receive and support a second divider generally distal from the floor without interference from a divider received in the first level portion. In some of these embodiments, the wall further comprises at least a second pair of divider receiving members enabled to receive a divider in one of a first level portion and a second level portion of the second pair of divider receiving members, such that a divider received in one of the first level portion and the second level portion of the second pair of divider receiving members is generally at an angle to a divider received in the other the first level portion and the second level portion of the first pair of divider receiving members. In some of these embodiments, the floor, the wall, the male portion, the female portion and the divider receiving members form a generally unified body.

In further embodiments of the first broad aspect, the modular cargo tray is generally comprised of thermoset plastic.

### BRIEF DESCRIPTIONS OF THE DRAWINGS

Embodiments are described with reference to the following figures, in which:

FIG. 1 depicts a perspective view of a utility cargo tray, according to a non-limiting embodiment;

FIG. 2 depicts a perspective view of a divider receiving member, according to a non-limiting embodiment;

FIG. 3 depicts a cross-section of a divider receiving member, according to a non-limiting embodiment;

FIG. 4 depicts a perspective view of a utility cargo tray in which dividers have been received, according to a non-limiting embodiment;

FIG. 5 depicts a perspective view of a utility cargo tray in which dividers have been received in a bi-directional manner, according to a non-limiting embodiment;

FIG. 6 depicts a perspective view of a utility cargo tray in use in the cargo area of a vehicle, according to a non-limiting embodiment;

FIG. 7 depicts a perspective view of a modular cargo tray, according to a non-limiting embodiment;

FIG. 8 depicts a perspective view of a modular cargo tray in which dividers have been received in a bi-directional manner, according to a non-limiting embodiment;

FIG. 9 depicts a perspective view of a utility cargo tray in which dividers have been received in a bi-directional manner and in use with cargo, according to a non-limiting embodiment;

FIG. 10 depicts a perspective view of a modular cargo tray in use in the cargo area of a vehicle, according to a non-limiting embodiment;

FIG. 11 depicts a perspective view of a modular cargo tray in a mating position with a second modular cargo tray, according to a non-limiting embodiment;

FIG. 12 depicts a cross-section of a modular cargo tray, according to a non-limiting embodiment;

FIG. 13 depicts a perspective view of a modular cargo tray in a mating position with a second modular cargo tray and secured with straps, according to a non-limiting embodiment;

FIG. 14 depicts a perspective view of a modular cargo tray in a mating position with a second modular cargo tray in use as a cargo roof box, according to a non-limiting embodiment;

FIG. 15 depicts a perspective view of an attachment portion, according to a non-limiting embodiment;

FIG. 16 depicts a cross-section of an attachment portion in use with a modular cargo tray and a roof top carrier, according to a non-limiting embodiment;

FIG. 17 depicts a perspective view of a modular cargo tray, according to a non-limiting embodiment;

FIG. 18 depicts a perspective view of a modular cargo tray in a mating position with a second modular cargo tray and secured via straps, according to a non-limiting embodiment;

FIG. 19 depicts a partial cross-section view of a modular cargo tray in a mating position with a second modular cargo tray, according to a non-limiting embodiment;

FIG. 20 depicts a perspective view of a modular cargo tray in a mating position with a second modular cargo tray in use as a cargo roof box, according to a non-limiting embodiment;

FIG. 21 depicts a perspective view of a modular cargo tray, according to a non-limiting embodiment; and

FIG. 22 depicts a perspective view of a modular cargo tray in which dividers have been received in a bi-directional manner, according to a non-limiting embodiment.

### DETAILED DESCRIPTION OF THE EMBODIMENTS

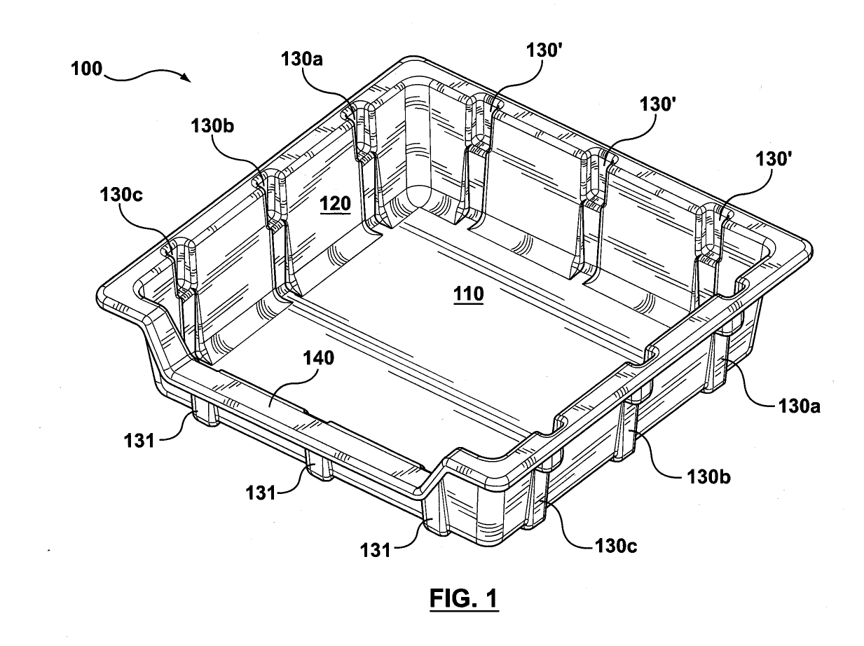

FIG. 1 depicts a perspective view of a utility cargo tray 100 according to a non-limiting embodiment. The utility cargo tray 100 comprises a floor 110 and a wall 120 extending from the floor 110, the floor 110 and the wall 120 enabled for storage of items placed therein. It is understood that the wall 120 forms a generally closed structure which extends generally continuously around the floor 110 to encompass items placed on the floor 110. Further, while the wall 120 and floor 110 form a generally rectangular shape, in other embodiments, the wall 120 and the floor 110 may form other shapes, including circular shapes, trapezoidal, elliptical, octagonal, or any other suitable shape.

The floor 110 and the wall 120 generally form a unified body. In some embodiments, the floor 110 and the wall 120 are enabled for insertion into the cargo area of a vehicle. Hence the dimensions of each of the floor 110 and the wall 120 may be commensurate with such an insertion. Further, the height of the wall 120 (i.e. the distance the wall 120 extends from floor 110) may be enabled for storing items of a particular size. For example, it may be desirable to store large items such as building materials or gardening materials in the utility cargo tray 100 and the wall 120 may hence be of a height for storing several stacked bags of cement, bags of dirt, plants and the like. However, any suitable height is within the scope of present embodiments. For example, the cargo area of a given vehicle may not accommodate a height that is commensurate with storing of certain building materials and hence a lower height may be desired that is compatible with the given vehicle.

Similarly the dimensions of the floor 110 may be enabled to store items of a particular size, adapted for the cargo area of a given vehicle, or a combination as desired.

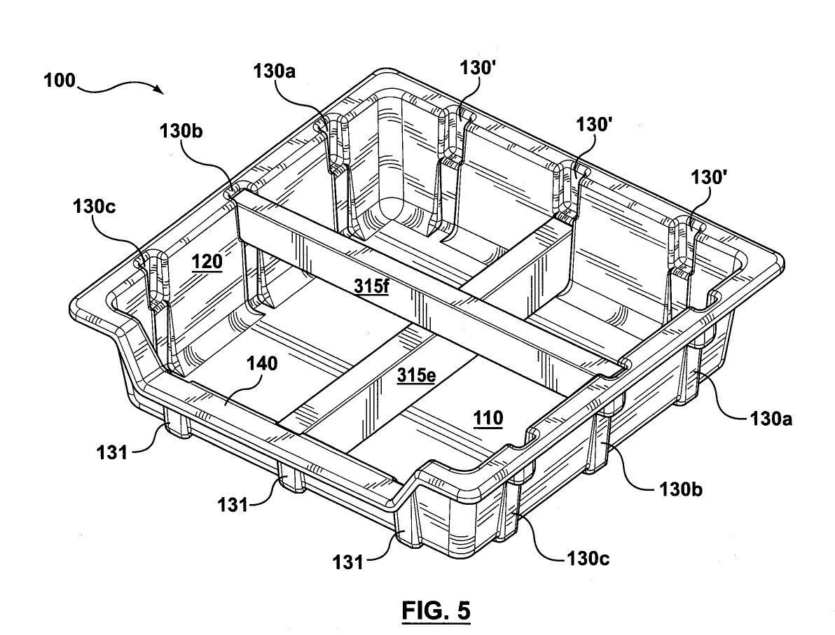

In the embodiment depicted in FIG. 1, the wall 120 further comprises an optional lower portion 140 along one section, which is of a lower height than the remaining sections of the wall 120. The optional lower portion 140 may assist in the placement and removal of items into and out of the utility cargo tray 100, when the cargo utility tray 100 is inserted into the cargo area of a vehicle, as described below with reference to FIG. 5. In some embodiments, the height of the optional lower portion 140 is similar to the height of a divider, as described below.

The wall 120 comprises divider receiving members 130 (collectively divider receiving members 130 and generically a divider receiving member 130), disposed along opposite sections of the wall 120, the opposite sections being generally perpendicular to the optional lower portion 140, if present. Specifically, the wall 120 comprises at least a first pair of the divider receiving members 130a, 130b, 130c, etc. (collectively the pairs of divider receiving members 130n and generically a pair of divider receiving members 130n) oppositely disposed along said wall 120. In some embodiments, the height of the wall 120 may also be similar to the height of at least one divider, and in some embodiments at least two dividers, as described below.

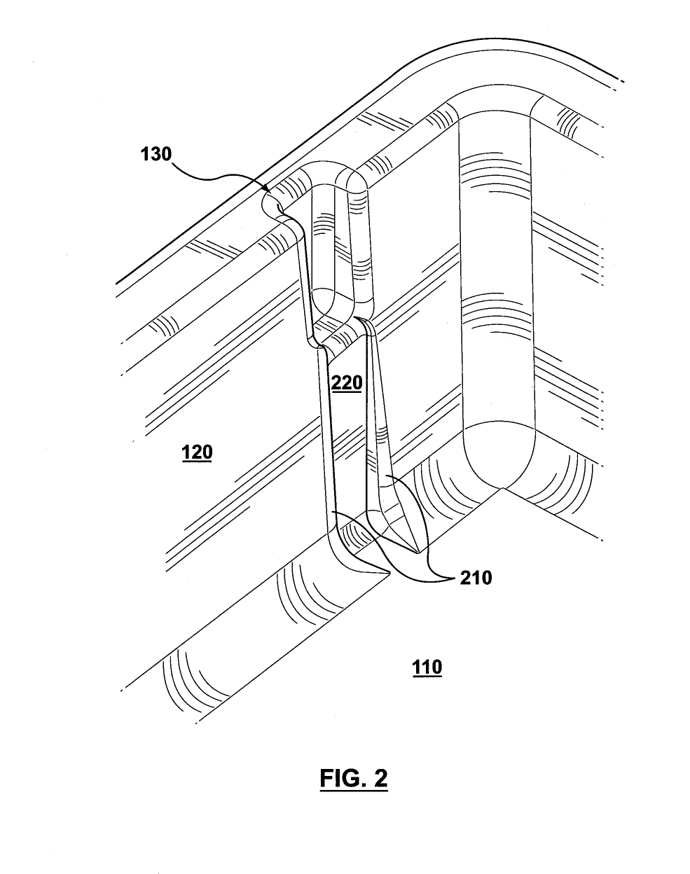

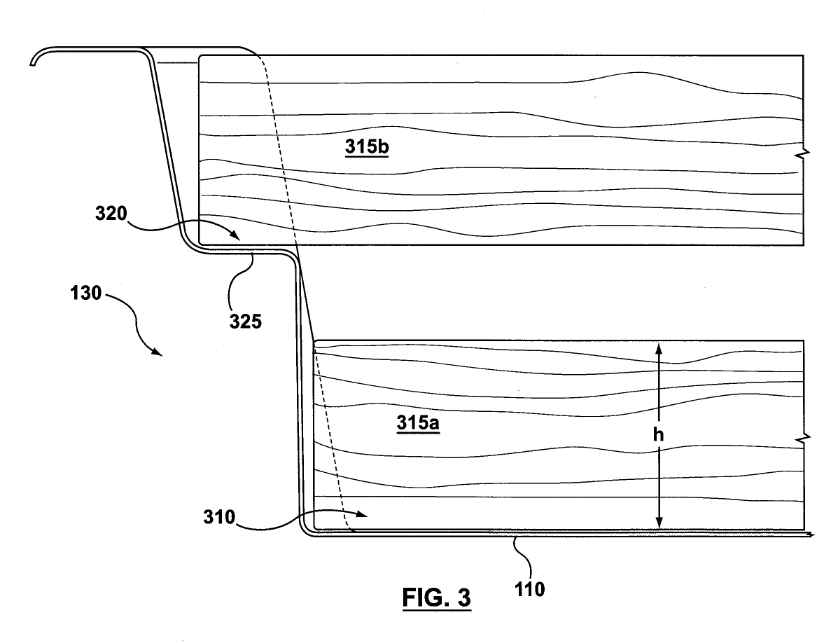

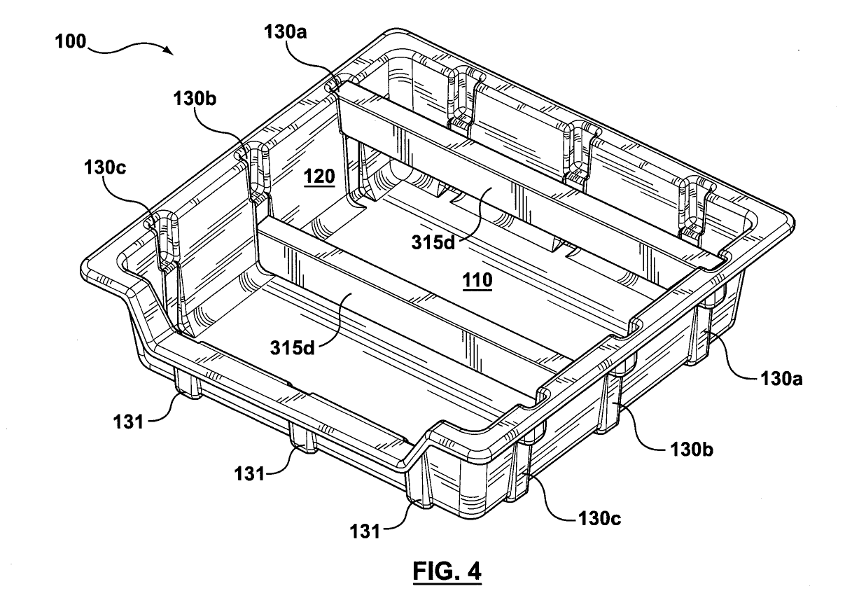

With reference to FIG. 2, which depicts a perspective of a divider receiving member 130 according to a non-limiting embodiment, each divider receiving member 130 generally comprises a groove 220 in the wall 120. In some embodiments, the groove 220 is formed by a pair of laterally disposed ribs 210 extending from the wall 120. In other embodiments the groove 220 may be a recessed groove. In any event the width of the groove 220 is similar to the width of a divider, such that at least one divider may slide into the groove 220, width-wise, and be supported by the lateral walls of the groove 220 in a lengthwise position relative to the floor 110. In general, each pair of divider receiving members 130n is enabled to receive at least one divider 315 (as in FIG. 3) thereby dividing the utility cargo tray 100 into at least two sections, for example see FIG. 4. In general, dividers 315 are referred to collectively as dividers 315 and generically as a divider 315. Further any suitable divider 315 may be used. In one particular non-limiting embodiment, the divider 315 may comprise a length of lumber, such as 2×4, a 2×6, etc., the pairs of divider receiving members 130n enabled to receive lumber such that special dividers need not be provided. Hence, a user may adapt standard sizes of lumber as desired, for example by cutting it to suitable length, for use with the utility cargo tray 100.

Attention is now directed to FIG. 3, which depicts a lateral cross-section of a divider receiving member 130 through the groove 220 of FIG. 2, the lateral walls of the groove 220 depicted in outline. Each divider receiving member 130 comprises a first level portion 310 enabled to receive a first divider 315a generally disposed along the floor 110. Each divider receiving member 130 further comprises a second level portion 320 enabled to receive and support a second divider 315b, the second divider 315b generally distal from the floor 110, without interference from the first divider 315a received in the first level portion 310. Hence, in a non-limiting embodiment, the second level portion 320 generally comprises a shelf 325 upon which the second divider can rest and be supported, that located a distance from the floor 110 that is at least the height, h, of the first divider 315a.

In some embodiments, the shelf 325 is continuously disposed between the lateral walls of the groove 220, and further extends to the back wall of the groove 220, as depicted (i.e. the back wall being generally parallel to the wall 120). However in other embodiments, the shelf 325 may occupy only a portion of the space within the groove 220. For example, in a non-limiting embodiment, the shelf 325 may comprise a partial shelf that extends from one lateral wall of the groove 220, but does not completely fill the space between the lateral walls of groove 220. In other non-limiting embodiments, the shelf 325 may comprise two partial shelves each of which extend oppositely from the lateral walls of the groove 220, but do not meet.

In general, the second level portion 320 is recessed from the first level portion 310 relative to the wall 120 such that the divider 315a does not interact with the second level portion 320 when inserted into the first level portion 310. However in some embodiments, the second level portion 320 is aligned with the first level portion 310 and, the shelf 325 comprises a removable strip of supporting material that extends between the lateral walls of the groove 220, but does not extend to the back wall of the groove 220. Hence, the strip of supporting material may be removed to insert a divider 315 into the first level portion 310 and re-inserted in the groove 220 such that another divider 315 into the second level portion 320.

FIG. 4 depicts a perspective view of the utility cargo tray 100, similar to FIG. 1 with like elements having like numbers, according to a non-limiting embodiment. In this view, however, dividers 315c and 315d have been respectively inserted into the pair of divider receiving members 130a and 130b, the divider 315c having been inserted into the second level portion 320 of the pair of the divider receiving members 130a, and the divider 315d having been inserted into the first level portion 310 of the pair of divider receiving members 130b. In general, in this embodiment, the divider 315c (or indeed any divider 315 that is insertable into the second level portion 320) is longer than the divider 315d (or any divider 315 that is insertable into the first level portion 310) due to the recessed nature of the shelf 325.

Returning briefly to FIG. 1, in some embodiments that comprise the optional lower portion 140, the wall 120 further comprises divider receiving members 130′ (collectively divider receiving members 130′ and generically a divider receiving member 130′), disposed along a section of the wall 120, opposite the optional lower portion 140. The divider receiving members 130′ are similar to the divider receiving members 130 described above, each having a first level portion 310 and a second level portion 320, etc.

In these embodiments the section of the wall 120 that comprises the optional lower portion 140, further comprises divider receiving members 131 (collectively divider receiving members 131 and generically a divider receiving member 131), generally located along the optional lower portion 140, each divider receiving member 131 disposed opposite to a divider receiving member 130′. Each divider receiving member 131 is similar to the divider receiving members 130 described above, however each divider receiving member 131 generally comprises only a first level portion 310. The height of the optional lower portion 140 of the wall 120 may preclude a second level portion from being integrated into each divider receiving member 131, for example in embodiments where the height of the optional lower portion 140 is similar to the height of a divider. In other embodiments, the optional lower portion 140 may comprise grooves disposed perpendicular to each of the divider receiving members 131 in a one to one relationship, and aligned with the second level portion 320 of the opposite divider receiving member 130′, each groove enabled to accept a divider 315 in the groove and hence support a divider 315 on the optional lower portion 140.

In any event, as depicted in FIG. 5 (substantially similar to FIG. 1 with like elements having like numbers) the placement of the oppositely disposed divider receiving members 130′ and divider receiving members 131 along sections of the wall 120, which are generally perpendicular to the sections of the wall 120 along which the pairs of divider receiving members 130n are disposed, enables dividers to be inserted into the utility cargo tray 100 generally perpendicular to one another. In this embodiment, a first divider 315e may be inserted into the first level portions 310 of oppositely disposed divider receiving members 130′ and divider receiving members 131, and a second divider 315f may be inserted into the second level portions 320 of a pair of divider receiving members 130n, the first divider 315e being disposed along the floor 110 and the second divider 315f being disposed perpendicular to the first divider 315f and raised from the floor 110.

While the depicted embodiments comprises three pairs of divider receiving members 130n, and similarly three pairs of oppositely disposed divider receiving members 130′ and 131, the number of pair of divider receiving members 130n, and pairs of oppositely disposed divider receiving members 130′ and 131 is not be considered particularly limiting.

Further, while the depicted embodiment the utility cargo tray 100 is enabled to receive dividers 315 in a generally perpendicular manner, in other embodiments the utility cargo tray 100 may be enabled to receive dividers 315 at angles other than 90°. For example, the pairs of divider receiving members 130n and pairs of oppositely disposed divider receiving members 130′ and 131 may be along segments of the wall 120 which are not perpendicular to each other, but at an angle different from 90°.

In yet further embodiments, the modular cargo tray 100 may comprise further pairs of divider receiving members, disposed along segments of the wall 120 which are at an angle to both the pairs of divider receiving members 130n and pairs of oppositely disposed divider receiving members 130′ and 131. For example if the wall 120 had an octagonal shape, then each opposite segment of the octagonal wall may comprise at least one pair of divider receiving members and/or a pair of oppositely disposed divider receiving members 130′ and 131. Hence, dividers may be received at 0° (i.e. parallel, as in FIG. 4), 45° or 90°.

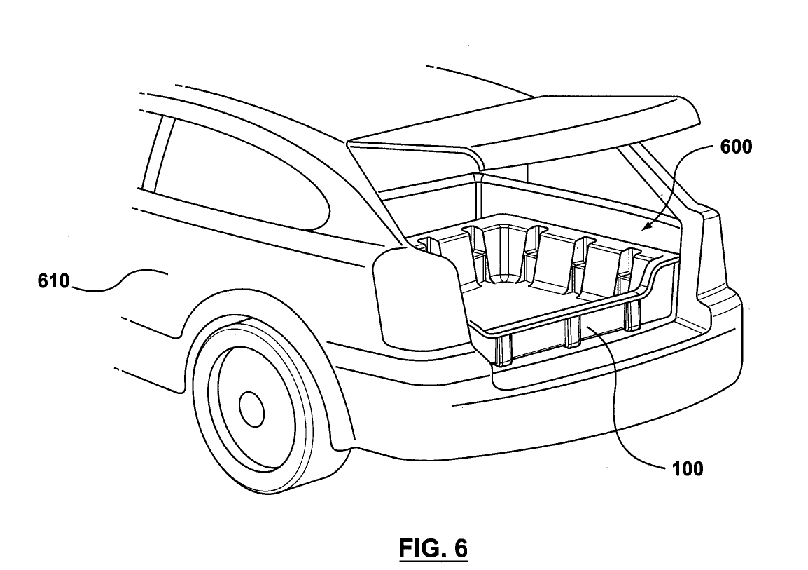

FIG. 6 depicts the utility cargo tray 100 inserted into the cargo area 600 of a vehicle 600 for protection of the cargo area 600 when items are placed therein.

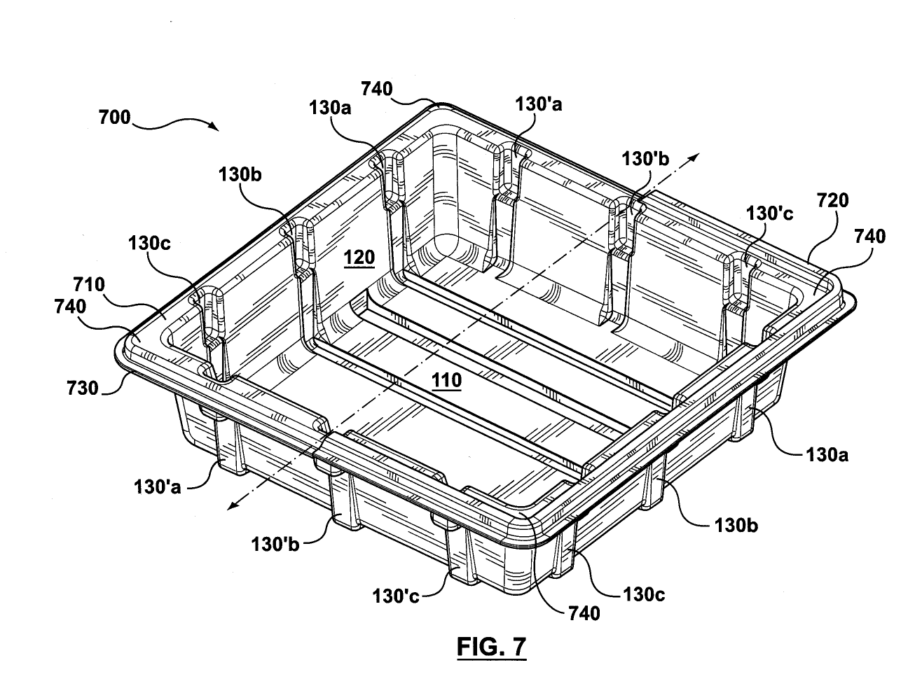

Turning now to FIG. 7, which depicts a modular cargo tray 700, according to a non-limiting embodiment. The modular cargo tray 700 is substantially similar to the utility cargo tray 100, with like elements depicted with like numbers, however the wall 120 of the modular cargo tray 700 has a height that is substantial similar around the circumference of the wall 120 (i.e. there is no optional lower portion 140 in the depicted non-limiting embodiment). Further, the wall 120 of the modular cargo tray 700 comprises the pairs of divider receiving members 130n. Similarly, the wall 120 of the modular cargo tray 700 comprises the divider receiving members 130′. Specifically, the wall 120 comprises at least a first pair of the divider receiving members 130′a, 130′b, 130′c, etc. (collectively the pairs of divider receiving members 130′n and generically a pair of divider receiving members 130′n) oppositely disposed along opposite sections of the wall 120, the opposite sections being generally perpendicular to the sections of the wall 120 along which the pairs of divider receiving members 130n are disposed.

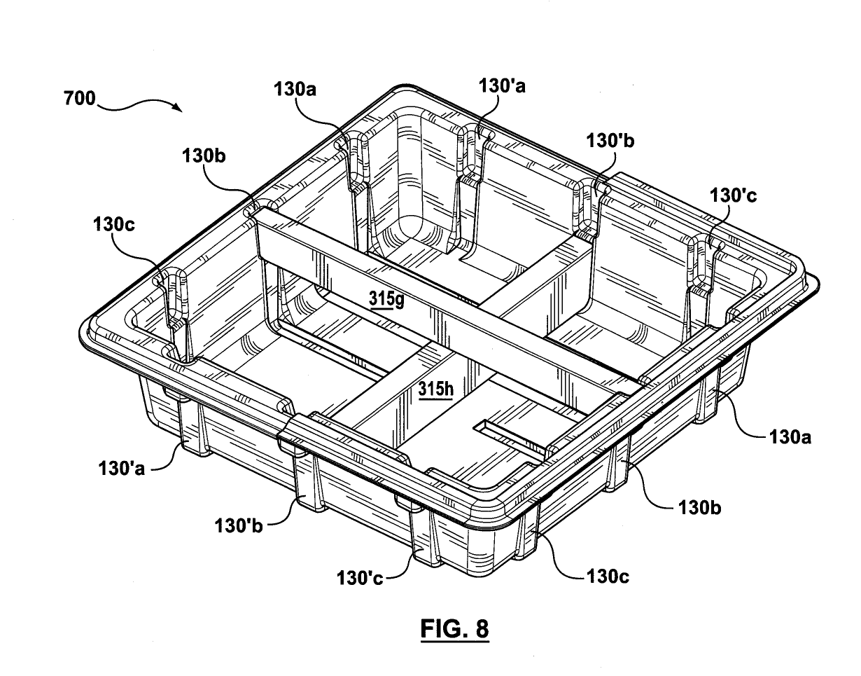

Hence, with reference to FIG. 8 (which is substantially similar to FIG. 7, with similar elements having similar numbers), the modular cargo tray 700 is enabled to receive a divider 315g in one of the first level portion 310 and the second level portion 320 (as depicted in FIG. 3) of a pair of divider receiving members 130′n, such that the divider 315g received in one of the first level portion 310 and the second level portion 320 of a pair of divider receiving members 130′n is generally perpendicular to a divider 315h received in the other the first level portion 310 and the second level portion 320 of a pair of divider receiving members 130n.

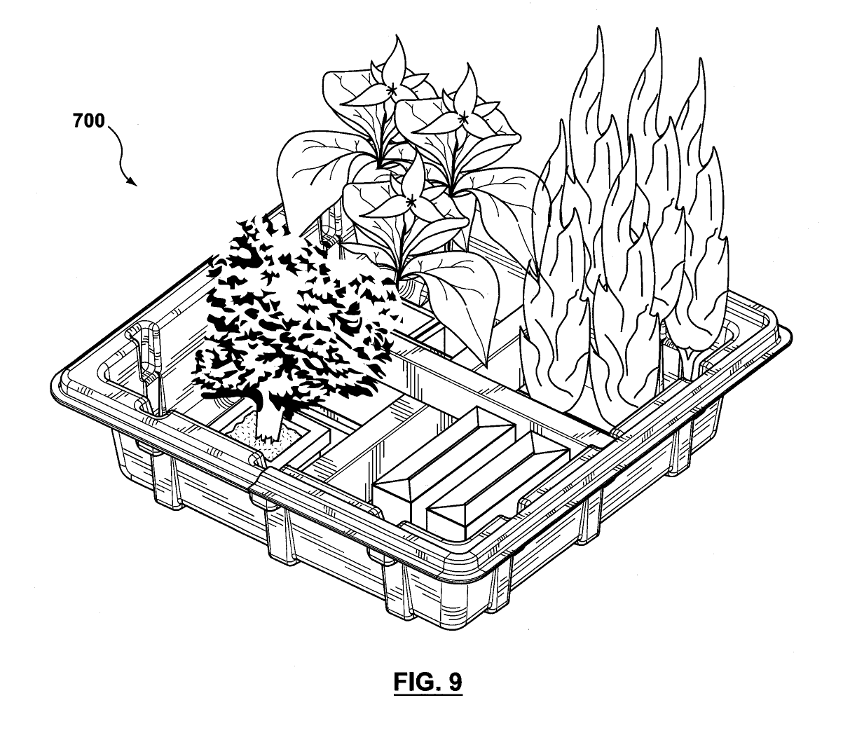

Hence, dividers 315 may be perpendicularly inserted into a pair of divider receiving members 130n and into a pair of divider receiving members 130′n, at one of two heights from the floor 110, thus dividing the modular cargo tray 700 into two or more sections. As depicted in FIG. 9, the two or more sections may be used to store items such as plants, building materials or any other items that a user wishes to store in the modular cargo tray 700.

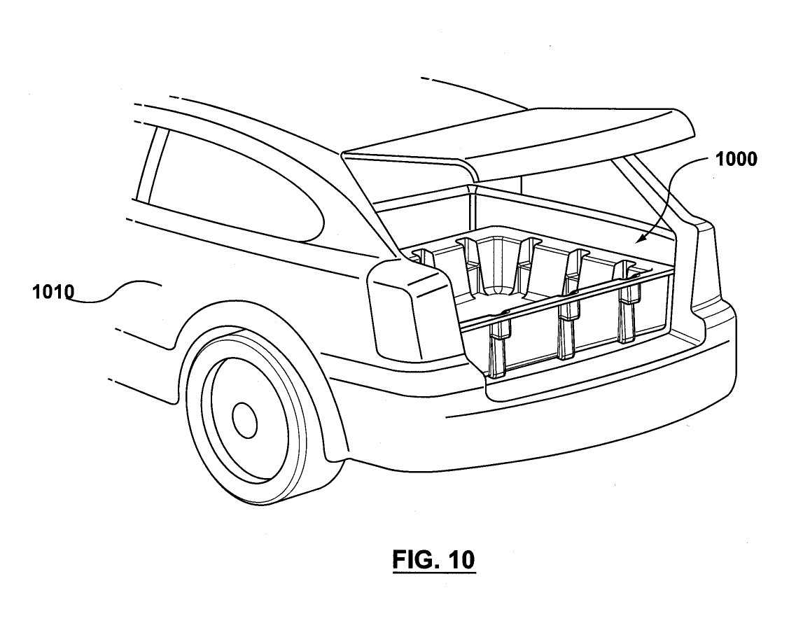

Further, as dividers 315 may be received into either the first level portions 310 or the second level portions 320 of either the pairs of divider receiving members 130n and/or the pairs of divider receiving members 130′n, there is versatility for a user who desires different options in storing items. For example, dividers 315 received in the second level portions 320 of either the pairs of divider receiving members 130n and/or the pairs of divider receiving members 130′n may provide more stability when storing the items as a divider 315 may be located closer to the center of mass of an item. Hence a divider 315 may not be exerting a substantial moment of force on the item. If the items are being transported in a vehicle (such in FIG. 10, which depicts the modular cargo tray 700 inserted into the cargo area 1000 of a vehicle 1010), such stability may prevent the items from falling over, for example when the vehicle changes speed rapidly during either acceleration or braking. Such convenience is also provided by the utility cargo tray 100.

Further, by providing more than one of the pairs of divider receiving members 130n and/or the pairs of divider receiving members 130′n, a user is provided with further storage options. For example, the user may desire to configure the dividers 315 in a particular manner to provide better stability to items stored in the modular cargo tray 700, by creating sections with the modular cargo tray 700 that are of size similar to the items to be stored in the modular cargo tray 700. Such convenience is also provided by the utility cargo tray 100.

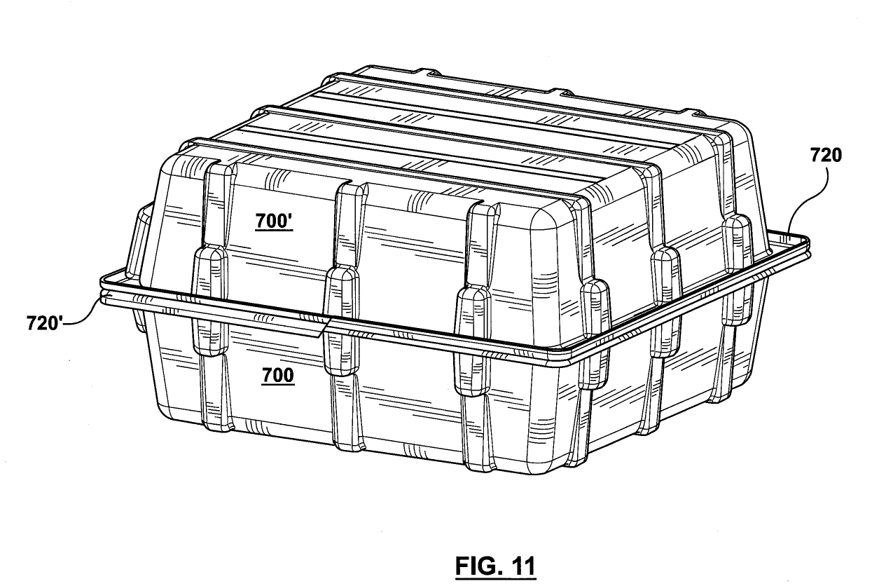

Returning to FIG. 7, the modular cargo tray 700 also comprises a rim 710, that in some embodiments encompasses the circumference of the wall 120 (as depicted), distal from the floor 110, while in other embodiments the rim 710 may encompass only portions of the wall 120, distal from the floor 110. In any event the modular cargo tray 700 also comprises a male portion 720 generally disposed about a first segment of the rim 710 and a female portion 730 generally disposed about a second segment of the rim 710. The male portion 720 and the female portion 730 are arranged generally symmetric to each other about a line bisecting the rim 710, for example the line AA which bisects the modular cargo tray 700 through opposed sections of the wall 120, away from corners 740 (collectively corners 740 and generically a corner 740) of the rim 710. The female portion 730 is generally enabled to mate with the male portion 720. For example, with reference to FIG. 11, when a second modular cargo tray 700′ is inverted over the modular cargo tray 700 in a mating position, the male portion 720 mates with the female portion 730′ of the second modular cargo tray 700′ and the female portion 730 mates with the male portion 720′ of the second modular cargo tray 700′, the male portion 720′ and the female portion 730′ of the second modular cargo tray 700′ being substantially similar to the male portion 720 and the female portion 730, respectively. Note that only the male portions 720 and 720′ are visible in FIG. 11, as the modular cargo trays 700 and 700′ are in a mating position; however it is understood that the female portions 730 and 730′ are nonetheless present.

While, in the depicted embodiment the line AA bisects the modular cargo tray 700 through opposed sections of the wall 120 away from corners 740, and specifically through those segments of the wall 120 where the pairs of divider receiving members 130′n are located, in other embodiments, the line AA may bisect the modular cargo tray 700 in any suitable manner that enables the male portion 720 and the female portion 730 of the modular cargo tray 700 to mate with the female portion 730′ and the male portion 720′, respectively, of the second modular cargo tray 700′ when the second modular cargo tray 700′ is inverted over the modular cargo tray 700. For example, the line AA may also bisect the modular cargo tray diagonally from a corner 740 to an opposite corner 740.

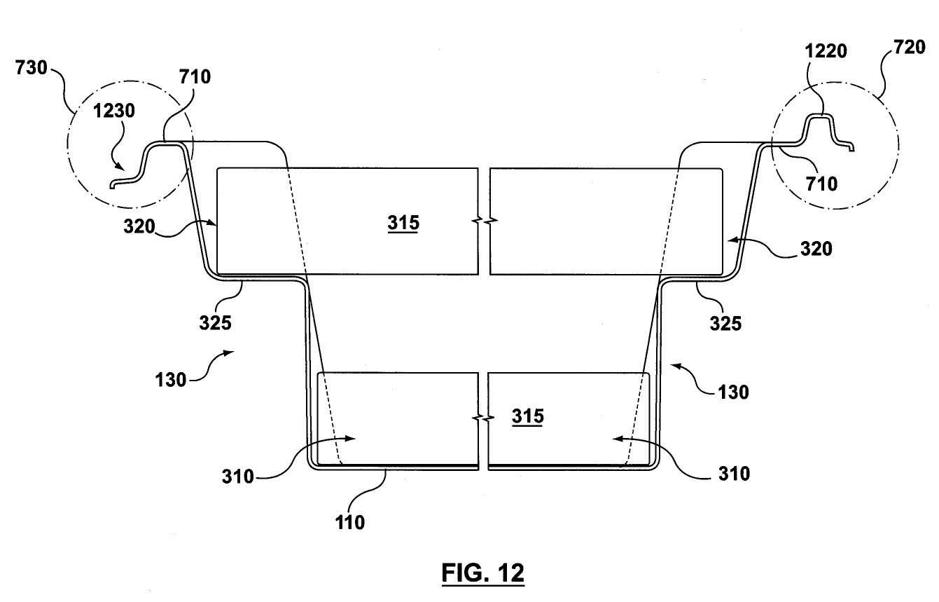

FIG. 12 depicts a lateral cross-section of the modular cargo tray 700 along a plane perpendicular to the line AA of FIG. 7 and the floor 110, and through a pair of divider receiving members 130n. Similar to FIG. 2, FIG. 12 depicts the first level portion 310, the second level portion 320 and the shelf 325 of each divider receiving member 130. FIG. 12 further depicts the dividers 315 received in each of the first level portion 310 and the second level portion 320.

FIG. 12 further depicts the male portion 720 and the female portion 730 in cross-section. In this embodiment, the male portion 720 comprises a rib 1220 extending from the rim 710 and the female portion 730 comprises a groove 1230. In this embodiment, the groove 1230 comprises a half groove (i.e. a groove open on one side), however in other embodiments the groove 1230 comprises a full groove (i.e. a groove having two walls defining the groove). In any event, the groove 1230 is configured to receive the rib 1220. For example, as in FIG. 11, the rib 1220 of the modular cargo tray 700 frictionally interlocks with the groove 1230′ (not visible in FIG. 11, but understood to be present) of the second modular cargo tray 700′, hence creating a seal around each rim 710 of each of the modular cargo trays 700 and 700′.

In some embodiments at least one of the male portion 720 and the female portion 730 further comprises an additional interlocking portion that actively and reversibly seals the rims 710, for example via an additional lip that snaps into an additional lip receiving groove. In any event, the second modular cargo tray 700′ is conveniently removable from the modular cargo tray 700 after the interlocking occurs.

While the height of the male portion 720 and corresponding depth of the female portion 730 is generally non-limiting, in some embodiments each of the male portion 720 and the female portion 730 are continuously disposed about the rim 710, and enhancing the frictional interlocking along the rim 710. Hence the general the height of the male portion 720 and corresponding depth of the female portion 730 may be reduced without substantially affecting the frictional interlocking.

Returning to FIG. 7, in some embodiments, each of the male portion 720 and the female portion 730 are continuously disposed about each respective segment of the rim 710. In some embodiments, a first end of the male portion 720 is generally adjacent to a first end of the female portion 730 along the rim 710, and a second end of the male portion 720 is generally adjacent to a second end of the female portion 730 along the rim 710. For example, each of the male portion 720 and the female portion 730 may extend from the line AA, around the rim 710 and end at the line AA on the opposite side of the rim 710. Hence a first end of each of the male portion 720 and the female portion 720 are generally adjacent to one another, and a second end of each of the male portion 720 and the female portion 720 are also generally adjacent to one another. In other embodiments, however, each said end are separated by a gap that spans each of the segments of the rim 710 that intersect the line AA.

Other types of suitable interlocking male portions 720 and female portions 730 are within the scope of present embodiments. For example, while the male portion 720 and the female portion 730 may be continuously disposed about each respective segment of the rim 710, the male portion 720 and the female portion 730 may not necessarily be inherently continuous structures. For example, in some embodiments, the male portion 720 may comprise a plurality of male sub-portions disposed about a first section of the rim 710 and the female portion 730 may comprise a plurality of female sub-portions disposed about the rim 710, each of the plurality of male sub-portions arranged generally symmetric to a corresponding one of the plurality of female sub-portions about the line AA of FIG. 7. For example, each of the male sub-portions may comprise a plurality of crenellated adjacent ribs each similar to the rib 1220 but each adjacent rib separated by a gap. Similarly, each of the male sub-portions may comprise a plurality of grooves for receiving each of the crenellated adjacent ribs, such that the second modular cargo tray 700′ may interlock with the cargo tray 700, as in FIG. 11. It is to be understood, however, that while the male portion 720 and the female portion 730 in these embodiments are not inherently continuous, they are nonetheless continuously disposed about the rim 710.

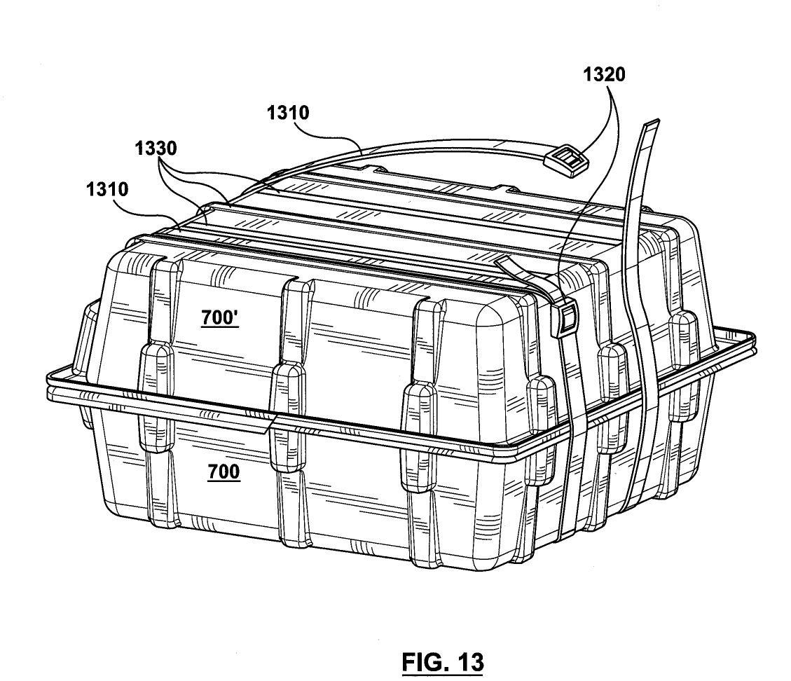

In some embodiments the mating between the modular cargo trays 700 and 700′ may be assisted via a securing apparatus for securing the modular cargo tray 700′ to the modular cargo tray 700. As depicted in FIG. 13, in some embodiments, the securing apparatus comprises at least one strap 1310 of a suitable length (and/or a rope, a cord, and the like) fastened around the modular cargo trays 700 and 700′. In some embodiments the strap 1310 further comprises a securing portion 1320 such as a buckle for securing and tightening the strap around the modular cargo trays 700 and 700′. To aid in the placement of the strap 1310 around the modular cargo trays 700 and 700′, each of the modular cargo trays 700 and 700′ may further comprise at least one of an exterior rib 1330 and/or an exterior groove (not depicted) for preventing the strap 1310 from slipping along the exterior each of the modular cargo trays 700 and 700′. In some embodiments, the at least one exterior 1330 rib may comprise an exterior portion of the divider receiving members 130 and/or 130′.

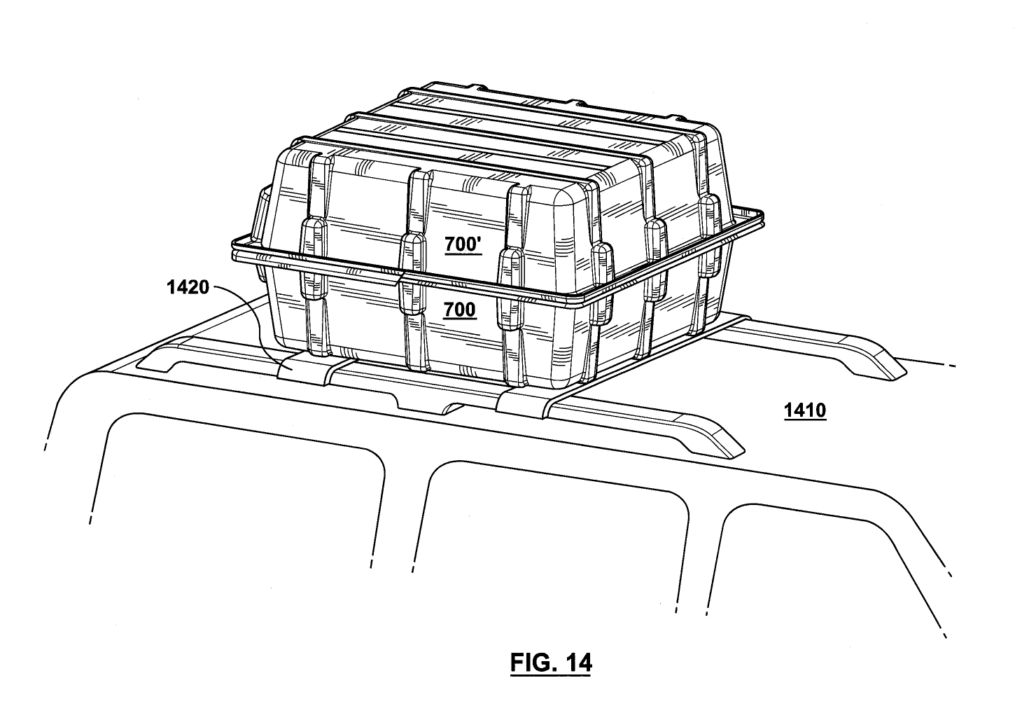

Hence, the male portion 720 and the female portion 730 generally enable the modular cargo tray 700 to be converted from a modular cargo tray insertable into the cargo area of a vehicle into a cargo roof box that is securable to the roof of a vehicle when mated with a second modular cargo tray. For example, FIG. 14 depicts the modular cargo trays 700 and 700′ in a mating position and in use as a cargo roof box on a roof of a vehicle 1410. As such the floor 110 and the wall 720 are enabled for securing to the roof of the vehicle 1410. In some embodiments securing to the roof of the vehicle 1410 comprises securing to a roof rack 1420 attached to the roof of the vehicle 1410, while in other embodiments securing to the roof of the vehicle 1410 comprises securing directly to the roof of the vehicle 1410, for example in the absence of the roof rack 1420.

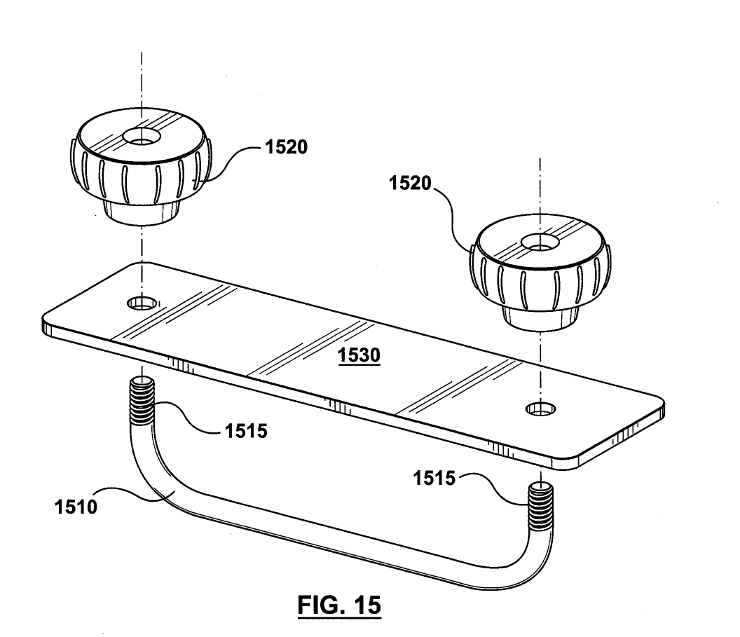

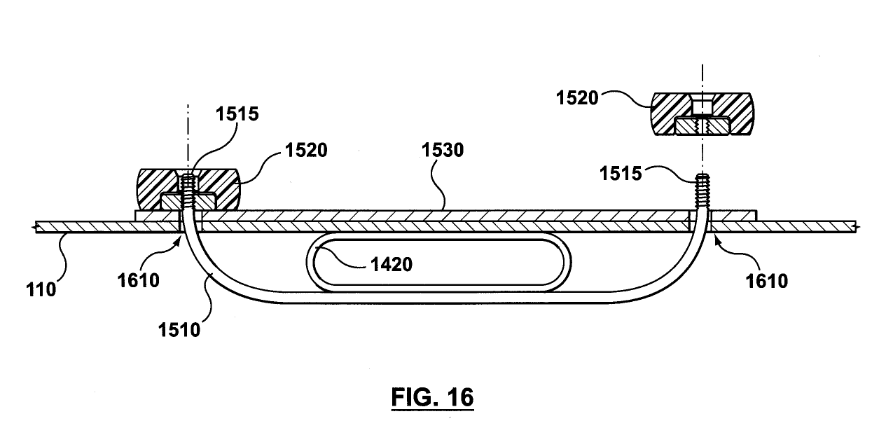

In some of these embodiments, including embodiments with and without a roof rack 1420, at least one of the floor 110 and the wall 120 is enabled for receiving at least one attachment portion for removably attaching the modular cargo tray 700 the roof of the vehicle 1410. For example, as depicted in FIG. 15, an attachment portion may comprise at least one u-bolt 1510 and apparatus for removably attaching the u-bolt 1510 to the floor 110. In the depicted embodiment, the u-bolt 1510 comprises threaded ends 1515, and the apparatus for removably attaching the u-bolt 1510 to the floor 110 comprises threaded thumbwheels 1520, which are fastenable onto the threaded ends 1515. In some of these embodiments, the apparatus for removably attaching the u-bolt 1510 to the floor 110 further comprises a plate 1530, such as a plate made from steel or another suitable material, having holes for receiving the ends 1515 there through. FIG. 16 depicts a cross-section of the attachment portion in use with the floor 110 of the modular cargo tray 700 and the roof rack 1420. The floor 110 of the modular cargo tray 700 is placed on the roof rack 1420, the floor 110 having been enabled to receive the ends 1515 of the u-bolt 1510 there through, for example via mating holes 1610. The u-bolt is then placed around a portion of the roof rack 1420 and the ends 1515 of the u-bolt 1510 are then inserted through the mating holes 1610. The plate 1530 (i.e. the holes of the plate 1530) is then placed onto the ends 1515 of the u-bolt 1510 such that the plate 1530 is in contact with the interior of the modular cargo tray 700 (i.e. the floor 110), and the threaded thumbwheels 1520 are then screwed onto the threaded ends 1515 thereby attaching the modular cargo tray 700 to the roof of the vehicle 1410. In other embodiments, threaded attachment portions other than the threaded thumbwheels 1520 may be used, such as nuts, winged nuts and the like. The plate 1530 is to be considered generally optional. In embodiments that do not include the roof rack 1420, the u-bolt 1510 may be placed through holes in the roof of the vehicle 1410.

In yet other embodiments, at least one strap of a suitable length may be used to secure the modular cargo trays 700 and 700′ to the roof of the vehicle 1410, as in FIG. 13, for example by securing modular cargo trays 700 and 700′ to the roof rack 1420. In these embodiments, the at least one strap is of a length to pass around both of the modular cargo trays 700 and 700′ when they are in a mating position, and further through the roof rack 1420.

Hence, the modular cargo tray 700 is suitable both for use in the cargo area of a vehicle, and adaptable for use as a cargo roof box, in combination with a second modular cargo tray 700′. A user is hence provided with versatility in transporting cargo. Further, in some embodiments, the modular cargo tray 700 may be enabled for insertion into the second cargo tray 700′ for easy storage and transport. In other words, the wall 120 may be angled such that the modular cargo tray 700 is stackable. Hence, a user may store two modular cargo trays 700 in a cargo area of vehicle, one on inserted into the other, and use them to transport cargo within the vehicle. Alternatively, only one cargo tray may be used in the vehicle. However, should the need arise the user may easily and conveniently secure the two modular cargo trays 700 onto the roof of the vehicle in the mating position for transport of cargo on the roof of the vehicle.

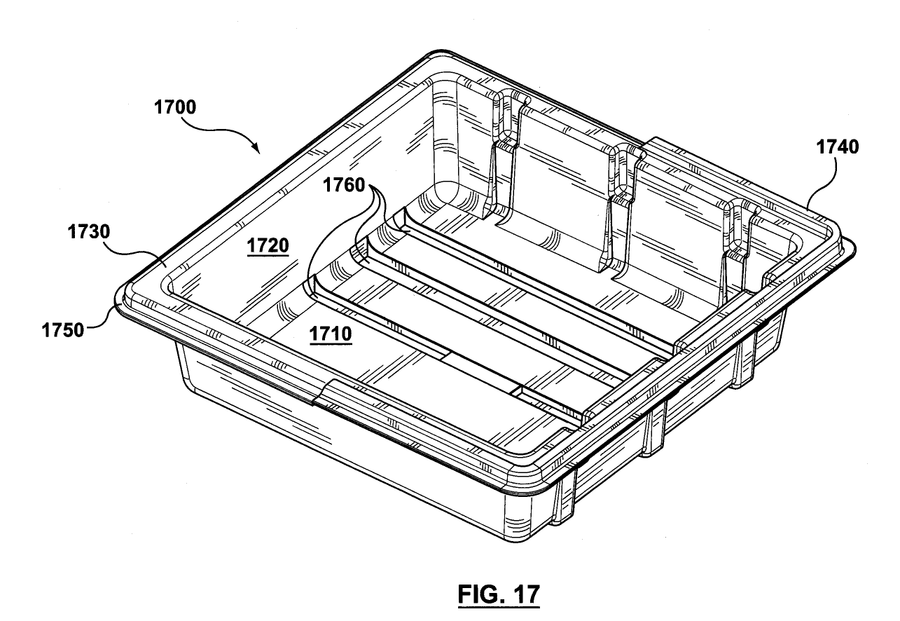

FIG. 17 depicts an alternative embodiment of a modular cargo tray 1700. In these embodiments, the modular cargo tray 1700 comprises a floor 1710, a wall 1720 extending from the floor 1710, the floor and the wall 1710 enabled for storage of items placed therein, and further enabled for at least one of insertion into a cargo area of a vehicle and securing to a roof of a vehicle, the wall 1720 comprising a rim 1730. In general the wall 1710 is similar to the wall 110 described above, the wall 1720 is similar to the wall 120 described above, and the rim 1730 is similar to the rim 710 described above. The modular cargo tray 1700 further comprises a male portion 1740 generally disposed about a first portion of the rim 1730, the male portion 1740 similar to the male portion 720 described above. The modular cargo tray further comprises a female portion 1750 generally disposed about a second portion of the rim 1730, the female portion 1750 similar to the female portion 730 described. In general, the male portion 1740 and the female portion 1750 are arranged generally symmetric to each other about a line BB bisecting the rim 1730, such that when a second modular cargo tray, similar to the modular cargo tray 1700 is inverted over the modular cargo tray 1700, the male portion 1740 mates with the female portion of the second modular cargo tray (similar to the female portion 1750) and the female portion 1750 mates with the male portion of the second modular cargo tray (similar to the male portion 1740).

In general the modular cargo tray 1700 is similar to the modular cargo tray 700, however the divider receiving members 130 and 130′ are absent from the modular cargo tray 1700. In some embodiments, the modular cargo tray 1700 further comprises at least one of an exterior rib and an exterior groove for assisting a securing apparatus, such as a strap etc, in securing a second modular cargo tray to the modular tray 1700 in a mating position. In FIG. 17, exterior ribs are visible as grooves 1760 in the floor 1710, each groove 1760 forming the interior of each exterior rib.

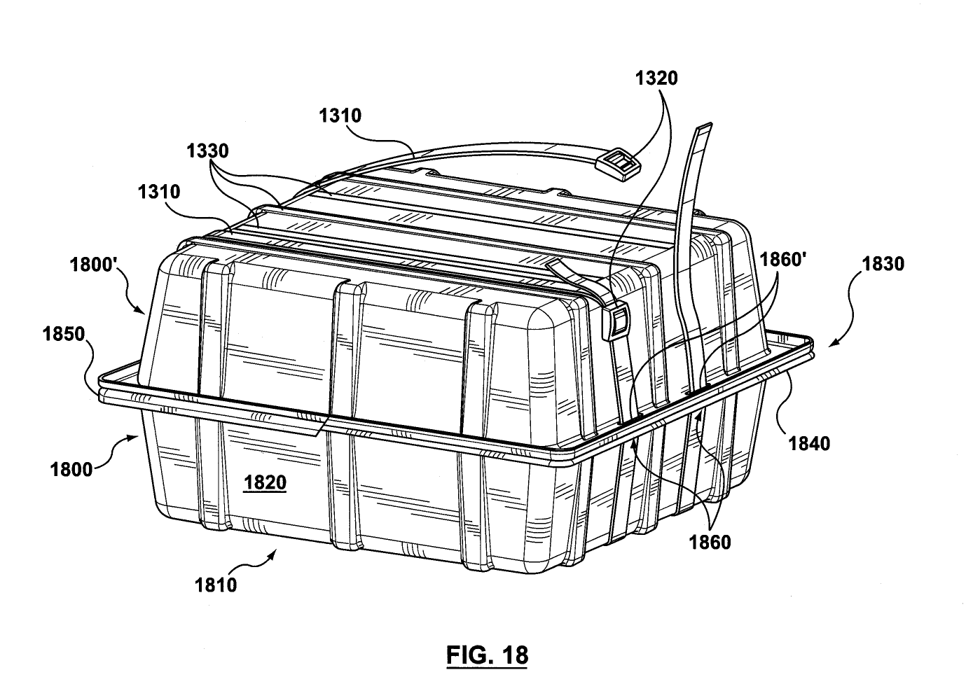

FIG. 18 depicts an alternative non-limiting embodiment of a modular cargo tray 1800. In these embodiments, the modular cargo tray 1800 comprises a floor 1810, a wall 1820 extending from the floor 1810, the wall 1820 comprising a rim 1830, and the modular cargo tray 1800 further comprising a male portion 1840 and a female portion 1850. In general, the floor 1810, the wall 1820, the rim 1830, the male portion 1840 and the female portion 1850 are similar, respectively, to the floor 110, the wall 120, the rim 710, the male portion 720 and the female portion 730 of the modular cargo tray 700. Also similar to the modular cargo tray 700, and as depicted, the modular cargo tray 1800 is enabled to mate with a second modular cargo tray 1800′.

In these embodiments, the modular cargo tray 1800 further comprises at least one pair of holes 1860 (generically a hole 1860, and collectively holes 1860) in the rim 1830, each hole 1860 of the at least one pair of holes 1860 symmetrically disposed about a line bisecting the modular cargo tray 1800 in manner similar to the line AA bisecting the modular cargo tray 700, described above. Hence, when the second modular cargo tray 1800′ is inverted over the modular cargo tray 1800, each hole 1860 of the at least one pair of holes 1860 lines up with a corresponding hole 1860′ in a pair of holes 1860′ of the modular cargo tray 1800′. In the depicted embodiment two holes 1860′ are visible on the modular cargo tray 1800′, each representing a different pair of holes 1860′, with the other hole 1860′ in the pair located opposite each hole 1860′ through the rim 1830 of the second modular cargo tray 1800′. While the other hole 1860′ is not visible in FIG. 18, it is understood that the other hole 1860′ in the pair is present.

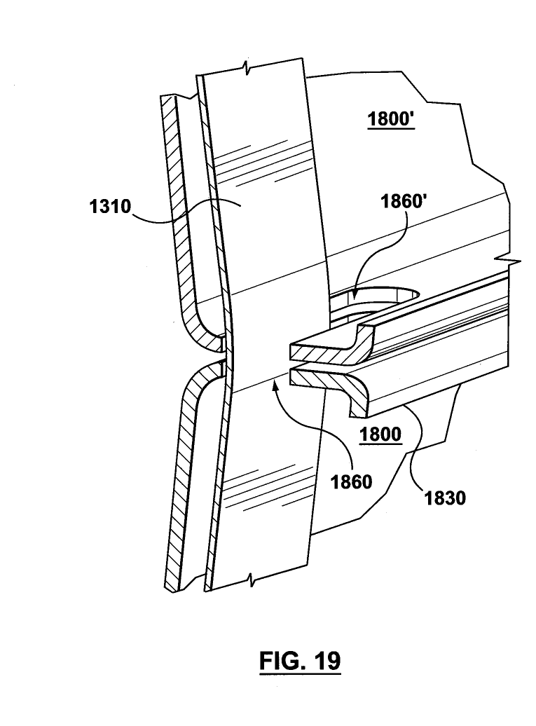

In some of these embodiments, each hole 1860 is enabled to accept the securing apparatus, described above, to aid in the securing of the modular cargo tray 1800′ to the modular cargo tray 1800. For example, as depicted in partial cross-section in FIG. 19, in embodiments which include the strap 1310, each hole 1860 may be enable to receive the strap 1310 there through and such that the strap 1310 may be threaded through the hole 1860. Hence, when the strap 1310 is tightened about the modular cargo trays 1800 and 1800′, the holes 1860 assist in holding the strap 1310 in place.

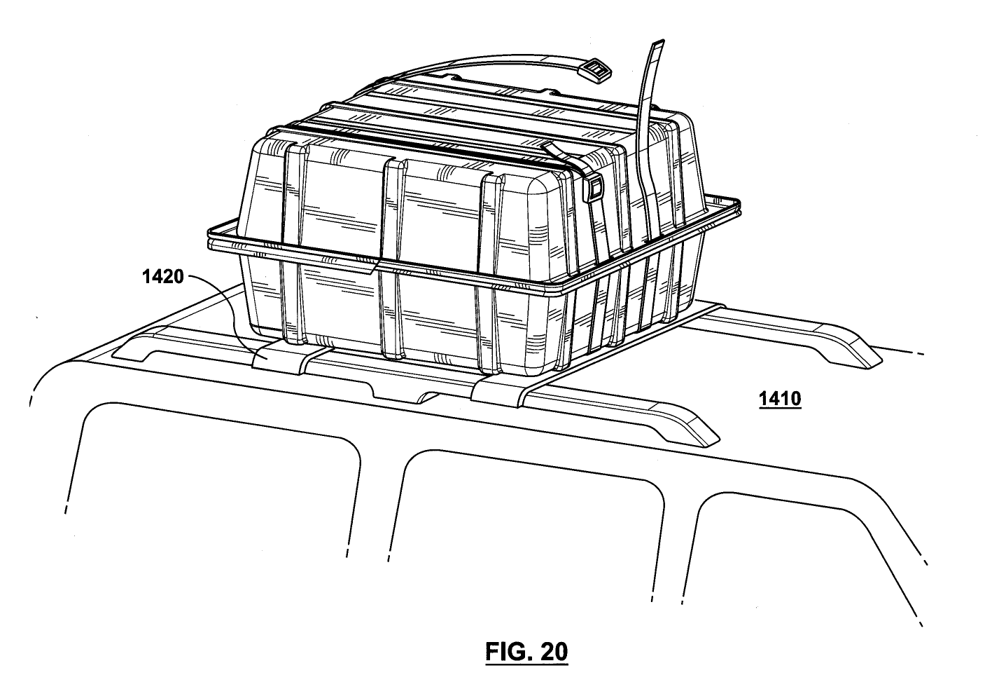

Further, as depicted in FIG. 20, the holes 1860 further aid in the securing of the modular cargo tray 1800 and the modular cargo tray 1800′ to the roof of a vehicle, when modular cargo tray 1800 and the modular cargo tray 1800′ are in a mating position.

Alternatively, in these embodiments, the securing apparatus may comprise any securing apparatus enabled for securing the modular cargo trays 1800 and 1800′ in a mating position via the holes 1860. For example, in some embodiments, the securing apparatus may comprise a tie, such as tie of the cable tie type, the holes 1860 being enabled to receive the tie. In other embodiments the securing apparatus may comprise a pin, such as a cotter pin, the holes 1860 enabled to receive the pin.

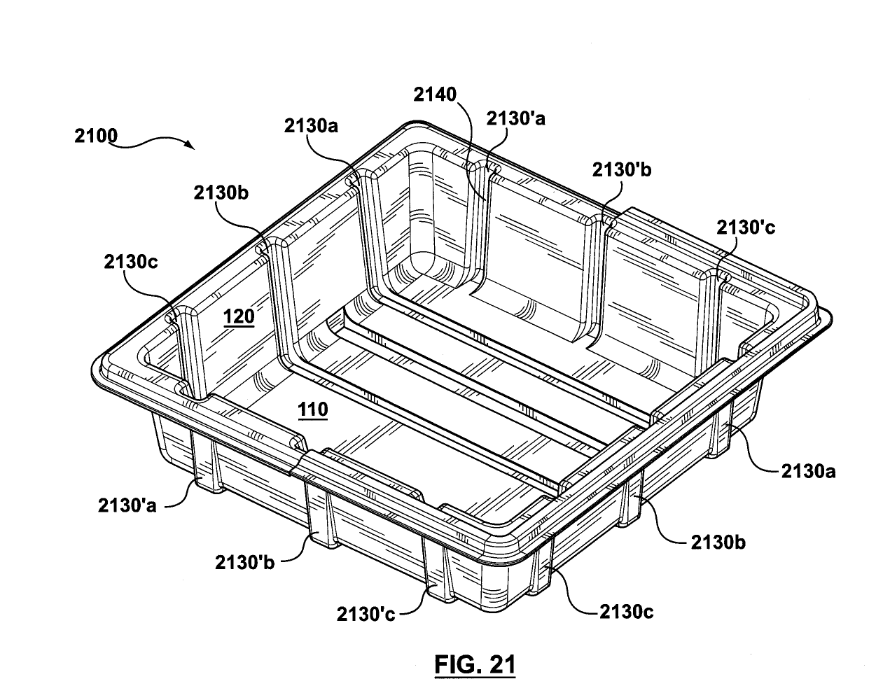

FIG. 21 depicts a perspective view of an alternative embodiment of a modular cargo tray 2100. The utility cargo tray 2100 is substantially similar to the modular cargo tray 700 and comprises the floor 110 and the wall 120. The utility cargo tray 2100 further comprises divider receiving members 2130 (referred to collectively as the divider receiving members 2130 and generically as a divider receiving member 2130) disposed along opposite sections of the wall 120. Specifically, the wall 120 comprises at least a first pair of the divider receiving members 2130a, 2130b, 2130c, etc. (collectively the pairs of divider receiving members 2130n and generically a pair of divider receiving members 2130n) oppositely disposed along said wall 120.

The utility cargo tray 2100 further comprises divider receiving members 2130′ (referred to collectively as the divider receiving members 2130′ and generically as a divider receiving member 2130′) disposed along opposite sections of the wall 120. Specifically, the wall 120 comprises at least a first pair of the divider receiving members 2130′a, 2130′b, 2130′c, etc. (collectively the pairs of divider receiving members 2130n and generically a pair of divider receiving members 2130n) oppositely disposed along opposite sections of the wall 120, the opposite sections being generally perpendicular to the sections of the wall 120 along which the pairs of divider receiving members 2130n are disposed.

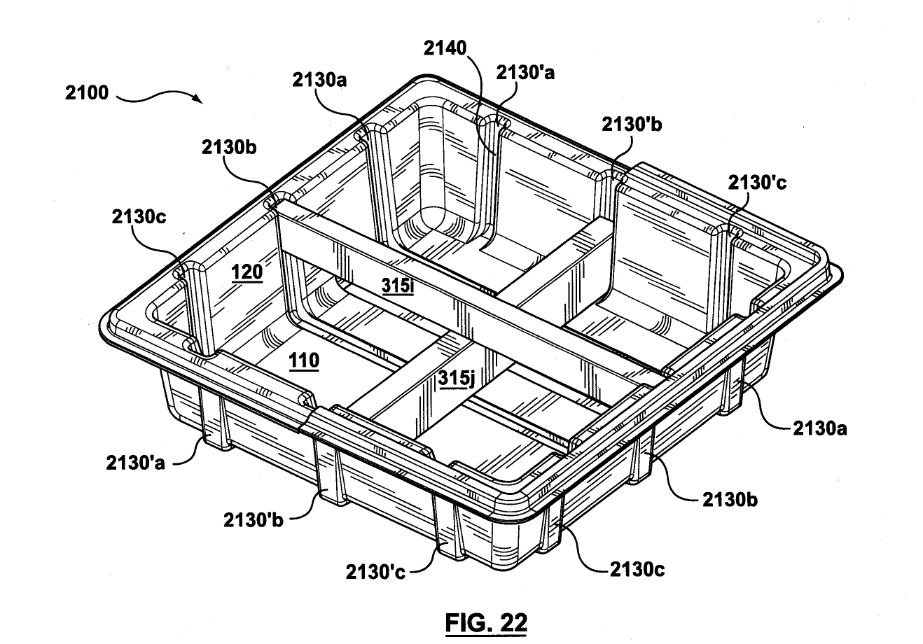

In these embodiments, each of the divider receiving members 2130 and 2130′ comprise a groove 2140 in the wall 120. In some embodiments, the groove 2140 is formed by a pair of laterally disposed ribs extending from the wall 120. In other embodiments the groove 2140 may be a recessed groove (as depicted). In any event the width of the groove 2140 is similar to the width of a divider, such that at least one divider may slide into the groove 2140, width-wise, and be supported by the lateral walls of the groove 2140 in a lengthwise position relative to the floor 110, as depicted in FIG. 22 (substantially similar to FIG. 21 with like elements having like numbers).

Unlike the divider receiving members 130 and 130′ of the modular utility tray 700, the divider receiving members 2130 and 2130′ do not comprise different level portions. However, each pair of divider receiving members 2130n is enabled to receive at least one divider 315 thereby dividing the utility cargo tray 100 into at least two sections. Hence, as depicted in FIG. 22 the placement of the pairs of divider receiving members 130′n along sections of the wall 120 which are generally perpendicular to the sections of the wall 120 along which the pairs of divider receiving members 2130n are disposed, enables dividers 315 to be inserted into the modular cargo tray 2100 generally perpendicular to one another. However in this embodiment, one of the dividers 315i resides at a height distal from the floor 110 by resting on another divider 315j which has been received in the pair of divider receiving members 2130′b (i.e. the divider 315j supports the divider 315i). Hence, the height distal from the floor 110 comprises the height of the divider 315j (similar to the height, h, of divider 315a in FIG. 3).

In some of these embodiments, the groove 1240 is generally perpendicular to the floor 110. In other embodiments, the groove 1240 may be at an angle greater than 90° relative to the floor 110. Hence, again with reference to FIG. 22, the divider 315j may be of a length that enables to the divider 315j to be supported by the divider 315j and by the back wall of the groove the groove 1240 (i.e. the back wall being generally parallel to the wall 120) of each. In other words, the bottom corners of the divider 315j are generally wedged into the grooves 1240 of each of the divider receiving members 2130 in the pair of divider receiving members 2130b. In some of these embodiments, the divider 315j may be of a length that enables to the divider 315j to be substantially supported by the back wall of the groove the groove 1240.

In general each of the utility cargo tray 100, and the modular cargo tray 700, 1700, 1800 and 2100 may be manufactured using any suitable thermoset plastic and any molding technique compatible with thermoset plastic, as known to one of skill in the art.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A utility cargo tray comprising,
a floor;
a wall extending from said floor, said wall and said floor enabled for storage of items placed therein, said wall comprising
at least a first pair of divider receiving members, oppositely disposed along said wall, said at least a first pair of divider receiving members comprising,
a first level portion enabled to receive a divider generally disposed along said floor; and
a second level portion enabled to receive and support a divider generally distal from said floor without interference from a divider received in said first level portion.

2. The utility cargo tray of claim 1, wherein said wall further comprises at least a second pair of divider receiving members enabled to receive a divider in at least a first level portion of said second pair of divider receiving members, such that a divider received in said first level portion of said second pair of divider receiving members is generally at an angle to a divider received in said second level portion of said first pair of divider receiving members.

3. The utility cargo tray of claim 1, wherein said wall further comprises at least a second pair of divider receiving members, enabled to receive a divider in one of a first level portion and a second level portion of said second pair of divider receiving members, such that a divider received in one of said first level portion and said second level portion of said second pair of divider receiving members is generally at an angle to a divider received in the other of said first level portion and said second level portion of said first pair of divider receiving members.

4. A modular cargo tray comprising,
a floor;
a wall extending from said floor, said floor and said wall enabled for storage of items placed therein, said floor and said wall further enabled for at least one of insertion into a cargo area of a vehicle and securing to a roof of said vehicle, said wall comprising a rim;
a male portion generally disposed about a first portion of said rim; and
a female portion generally disposed about a second portion of said rim, said male portion and said female portion being arranged generally symmetric to each other about a line bisecting said rim, such that when a second modular cargo tray is inverted over the modular cargo tray in a mating position, said male portion mates with the female portion of the second modular cargo tray and said female portion mates with the male portion of the second modular cargo tray.

5. The modular cargo tray of claim 4, wherein said male portion is generally continuously disposed about said first portion of said rim and said female portion is generally continuously disposed about said second portion of said rim.

6. The modular cargo tray of claim 4, wherein when said second modular cargo tray and the modular cargo tray are in said mating position, said male portion mating with the female portion of the second modular cargo tray and said female portion mating with the male portion of the second modular cargo tray generally creates a seal along each said rim of each said modular cargo tray.

7. The modular cargo tray of claim 6, wherein a first end of said male portion is generally adjacent to a first end of said female portion along said rim, and a second end of said male portion is generally adjacent to a second end of said female portion along said rim.

8. The modular cargo tray of claim 6, wherein at least one gap separates at least one of said first ends of each said male portion and said female portion along said rim, and said second ends of each said male portion and said female portion along said rim.

9. The modular cargo tray of claim 4, wherein each said male portion comprises a plurality of male sub portions and said female portion comprises a plurality of female sub portions, each of said plurality of male sub portions arranged generally symmetric to a corresponding one of said plurality of female sub portions about said line bisecting said rim.

10. The modular cargo tray of claim 4, wherein said securing to said roof of said vehicle comprises securing to a roof rack.

11. The modular cargo tray of claim 4, wherein at least one of said floor and said wall is enabled for receiving at least one attachment portion for removably attaching the modular cargo tray to said roof of said vehicle.

12. The modular cargo tray of claim 11, wherein said at least one attachment portion comprises at least one u-bolt and apparatus for removably attaching said u-bolt to at least one of said floor and said wall.

13. The modular cargo tray of claim 11, wherein said at least one attachment portion comprises at least one strap of a length for attaching the modular cargo tray to said roof of said vehicle, said strap comprising a strap securing portion.

14. The modular cargo tray of claim 13, wherein at least one of said floor and said wall further comprises at least one of an exterior rib and an exterior groove for receiving said at least one strap.

15. The modular cargo tray of claim 4, further comprising at least one pair of holes in said rim, each hole of said at least one pair of holes symmetrically disposed about said line bisecting said rim, wherein when the second modular cargo and the modular cargo tray are in said mating position, each hole of said at least one pair of holes lines up with a corresponding hole in a pair of holes in the rim of the second modular cargo tray.

16. The modular cargo tray of claim 15, wherein each said hole is enabled to accept a securing apparatus for securing the second modular cargo tray to the modular cargo tray.

17. The modular cargo tray of claim 4, further comprising apparatus for securing the second modular cargo tray to the modular cargo tray in said mating position.

18. The modular cargo tray of claim 4 wherein said male portion comprises a raised rib and said female portion comprises a recessed groove enabled to receive said raised rib.

19. The modular cargo tray of claim 18, wherein said raised rib and said recessed groove are further enabled to interlock with each other.

20. The modular cargo tray of claim 4, wherein said floor, said wall, said male portion and said female portion form a generally unified body.

21. The modular cargo tray of claim 4, wherein said wall comprises at least a first pair of divider receiving members, oppositely disposed along said wall, enabled to receive at least one divider, thereby dividing the modular cargo tray into at least two sections.

22. The modular cargo tray of claim 21, wherein each said divider receiving member comprises
a first level portion enabled to receive a first divider generally disposed along said floor; and
a second level portion enabled to receive and support a second divider generally distal from said floor without interference from a divider received in said first level portion.

23. The modular cargo tray of claim 22, wherein said wall further comprises at least a second pair of divider receiving members enabled to receive a divider in one of a first level portion and a second level portion of said second pair of divider receiving members, such that a divider received in one of said first level portion and said second level portion of said second pair of divider receiving members is generally at an angle to a divider received in the other said first level portion and said second level portion of said first pair of divider receiving members.

24. The modular cargo tray of claim 23, wherein said floor, said wall, said male portion, said female portion and said divider receiving members form a generally unified body.

25. The modular cargo tray of claim 4, wherein said modular cargo tray is generally comprised of thermoset plastic.
